(19) United States
(12) Patent Application Publication
(10) Pub. No.: US 2006/0104414 A1
(43) Pub. Date: May 18, 2006

(54) Combinatorial contraband detection using energy dispersive x-ray diffraction

(76) Inventor: William E. Mayo, Piscataway, NJ (US)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 10/503,108

(22) PCT Filed: Jan. 29, 2003
(86) PCT No.: PCT/US03/02654

§ 371 Date: Jul. 25, 2005

Related U.S. Application Data
(60) Provisional application No. 60/352,952, filed on Jan. 30, 2002.

(51) Int. Cl. G01N 23/04

(52) U.S. Cl. 378/57

(57) ABSTRACT

Articles such as luggage to be carried aboard aircraft are screened by a first stage examination unit (14) such as a CT scanning unit which identifies suspect regions (16) having a relatively high probability of containing contraband. Articles containing such suspect regions are then examined at a physically separate unit (20) by energy dispersive x-ray diffraction (EDXD) with diffraction occurring at locations within the identified suspect regions. Because EDXD examination is concentrated on the suspect regions, the EDXD examination can be performed rapidly.

### CROSS-REFERENCE TO RELATED APPLICATIONS

The present application claims benefit of U.S. Provisional Patent Application Ser. No. 60/352,952, filed Jan. 30, 2002′, the disclosure of which is incorporated by reference herein.

### TECHNICAL FIELD

The present invention relates to apparatus and methods for detecting contraband.

### BACKGROUND ART

In many applications, it is required to detect contraband such as narcotics and explosive devices. For example, luggage to be carried aboard an airline must be screened for explosive devices. The principal technologies employed today include manual searching and x-ray inspection to form an image of the internal contents of the luggage, which is then viewed by a human screener. Both techniques require constant vigilance by a human observer. These techniques are labor-intensive and depend upon a vast force of workers who must be trained and monitored to maintain their vigilance. Moreover, the boring, repetitive task itself tends to dull the observer's vigilance with time.

Various proposals have been advanced for automated screening devices. The most widely used automated screening device for examining checked baggage on airlines today is a computerized tomographic x-ray unit linked to an artificial intelligence system. Other technologies which have been proposed include trace chemical analysis apparatus, commonly referred to as “sniffer” apparatus, which uses techniques such as mask spectroscopy, to find minute traces of explosives of the outside of the luggage or in the atmosphere surrounding the luggage. Additional x-ray techniques such as multi-energy x-ray measurements to determine x-ray density, Compton scattering and x-ray backscatter detection have been employed or proposed.

As disclosed in U.S. Pat. No. 6,118,850, of Mayo et al. (“the '850 patent”), energy dispersive x-ray diffraction (“EDXD”) can also be used to detect contraband concealed in luggage or in other objects. The disclosure of the '850 patent is hereby incorporated by reference herein. As further described in the '850 patent, in EDXD a source directs an incident x-ray beam including x-rays at various wavelengths along a path through a test object such as a piece of luggage being examined. As the beam passes through the test object, diffraction occurs. Diffraction causes a portion of the incident x-ray beam to be deflected from the path of the incident beam. A radioopaque plate with a narrow opening is arranged to pass only a narrow beam of x-rays diffracted along a pre-selected diffracted beam path intersecting the incident beam path at a location referred to herein as the “diffraction location.” The x-rays passing through the opening are monitored so as to provide a spectrum of the diffracted x-rays as a function of wavelength. Diffraction depends upon the interaction between the incident x-ray beam and the crystalline structure in the material being examined. For any given substance, x-rays at a few wavelengths will be substantially diffracted at the angle required to route the x-rays along the pre-selected diffracted beam path, whereas x-rays at other wavelengths will not. Thus, the spectrum of the diffracted x-rays will have a characteristic pattern. This pattern varies with the crystalline structure and, hence, the chemical nature of the substance which is present at the diffraction location.

Contraband such as explosives can be detected by comparing the spectrum of the diffracted x-ray beam with the spectra for known explosives. As described in greater detail in the '850 patent, a portion of the original incident beam passing through the luggage can be examined to derive a transmission spectrum. The spectrum of the diffracted x-rays can be “normalized” so as to compensate for effects such as attenuation of the x-rays during transmission through the luggage or non-uniformities in the spectrum of the original incident x-ray beam. The normalized diffraction spectrum is then examined to extract a “feature set” including multiple parameters of the normalized diffraction spectrum. The feature set is then subjected to a probabilistic classification scheme such as processing in a neural network or decision tree to derive a probability that the spectrum is, in fact, the spectrum of a substance to be identified such as a known explosive.

Three main requirements must be met for a truly satisfactory contraband detection system. First, the system must have a low false-negative rate, i.e., the system should not often fail to provide an alarm when contraband is present in a piece of luggage being screened. Second, the system should have a low false-positive rate; it should not issue too many false alarms when no contraband is present. Third, the system should be capable of examining luggage at a rapid rate as, for example, hundreds or, preferably thousands or tens of thousands of pieces per hour. Although significant efforts have been devoted heretofore to development of contraband detection systems, none of the systems available heretofore has provided an optimum balance of all of these characteristics.

### SUMMARY OF THE INVENTION

One aspect of the invention provides methods of examining a series of articles as, for example, luggage, in order to detect contraband concealed therein. A method according to this aspect of the invention desirably includes the step of conducting an initial examination of each article at an initial examination unit as, for example, a CT scanner, to identify suspect regions which are more likely than other regions of such article to contain contraband and to provide location information including the locations of the suspect regions within each article where such suspect regions are found. The method further includes the step of moving at least those articles in which suspect regions are identified to an EDXD examination unit physically separate from the initial examination unit, and conducting EDXD examination of those articles at the EDXD unit. The EDXD examination is conducted for at least those articles in which suspect regions are identified, so as to provide one or more suspect region diffraction signals representing one or more X-ray diffraction spectra of material present in said suspect regions. The method also includes the step of classifying at least some of the articles as likely to contain contraband or as not likely to contain contraband based at least in part upon the suspect region diffraction signals. Most preferably, the EDXD examination does not involve examination of every region of the object. That is, the EDXD examination is performed without conducting EDXD examination of at least some regions other than suspect regions in at articles having suspect regions.

Methods according to this aspect of the invention incorporate the realization that EDXD examination has unique is properties which make it particularly suitable for use in conjunction with imaging examination techniques as, for example, CT scanning. The imaging techniques can examine an entire piece of luggage, but are not particularly good at discriminating contraband from other materials. Attempts to classify luggage based on the results of an imaging technique alone, or even on the results of two distinct imaging techniques in combination, typically will suffer from high false positive or false negative rates, particularly when operated at the rates required for practical application in luggage screening. EDXD provides good discrimination, but operates relatively slowly because it inherently examines only a small volume element, or a few volume elements in a single measurement. By using an imaging technique to provide a first stage, crude indication of suspect regions, and by concentrating EDXD examination in these regions, the preferred methods according to this aspect of the invention can radically reduce the time required for EDXD examination without substantially compromising the discrimination ability of the EDXD system. Moreover, the logic used in the initial examination can be prejudiced toward false positives and hence can have a reasonable false negative rate. The EDXD examination step will reject the false positives.

By using an EDXD unit physically separate from the initial examination unit, throughput can be further enhanced. Most preferably, the units are operated so that while the EDXD unit is examining one article, the initial examination unit is examining another article. The step of moving articles from the initial examination unit to the EDXD examination unit most preferably is conducted using gentle acceleration and desirably without reorienting each article relative to gravity, so that the contents of each article, including any contraband to be detected, remain in place.

A further aspect of the invention provides apparatus including an imaging first stage as, for example, a computerized tomographic (“CT”) or other device capable of identifying suspect regions and providing data as to their locations within individual articles, an EDXD stage and a positioner responsive to the location data for placing a diffraction location of the EDXD apparatus within each suspect region. Here again, the EDXD unit desirably is physically separate from the first stage or initial examination unit.

Yet another aspect of the invention provides methods of examining articles by X-ray diffraction using an intermittently-operated or “flash” X-ray source. A method according to this aspect of the invention desirably includes the step of specifying a set of regions within an object to be examined, which regions include less than all of the object. The method further includes moving the object relative to EDXD apparatus incorporating an X-ray source adapted to direct an incident X-ray beam along an incident beam path and a detector sensitive to x-rays directed along a diffracted beam path intersecting the incident beam path at a diffraction location. The moving step is performed so as to successively align regions in the set with the diffraction location. The method further includes the step of actuating the X-ray source intermittently, in synchronism with the moving step, so that the X-ray source provides said incident X-ray beam when a region in the set is aligned with the diffraction location. However, during at least some times when no region in said set is aligned with the diffraction location, the X-ray source does not provide the incident X-ray beam. Using the detector, spectra of diffracted X-rays from regions in the set are acquired while the incident beam is provided by the X-ray source.

Because the X-ray source is operated only intermittently, it can provide a high-intensity X-ray beam and hence can provide spectra with good signal-to-noise ratio. Although the X-ray source is inoperative for part of the process, this does not increase the overall examination time. The inoperative periods of the X-ray source occur when none of the preselected regions of the article are aligned with the diffraction location as, for example, during movement of the article. Most preferably, the step of specifying the set of regions includes conducting an initial examination of the article as discussed above.

Yet another aspect of the invention provides EDXD examination apparatus incorporating a positioner, an X-ray source and a controller for coordinating the positioner and the X-ray source as discussed above.

### BRIEF DESCRIPTION OF THE DRAWINGS

FIG. 1 is a diagrammatic plan view of apparatus according to one embodiment of the invention.

FIG. 2 is a diagrammatic sectional view depicting a portion of the apparatus shown in FIG. 1.

### BEST MODE FOR CARRYING OUT INVENTION

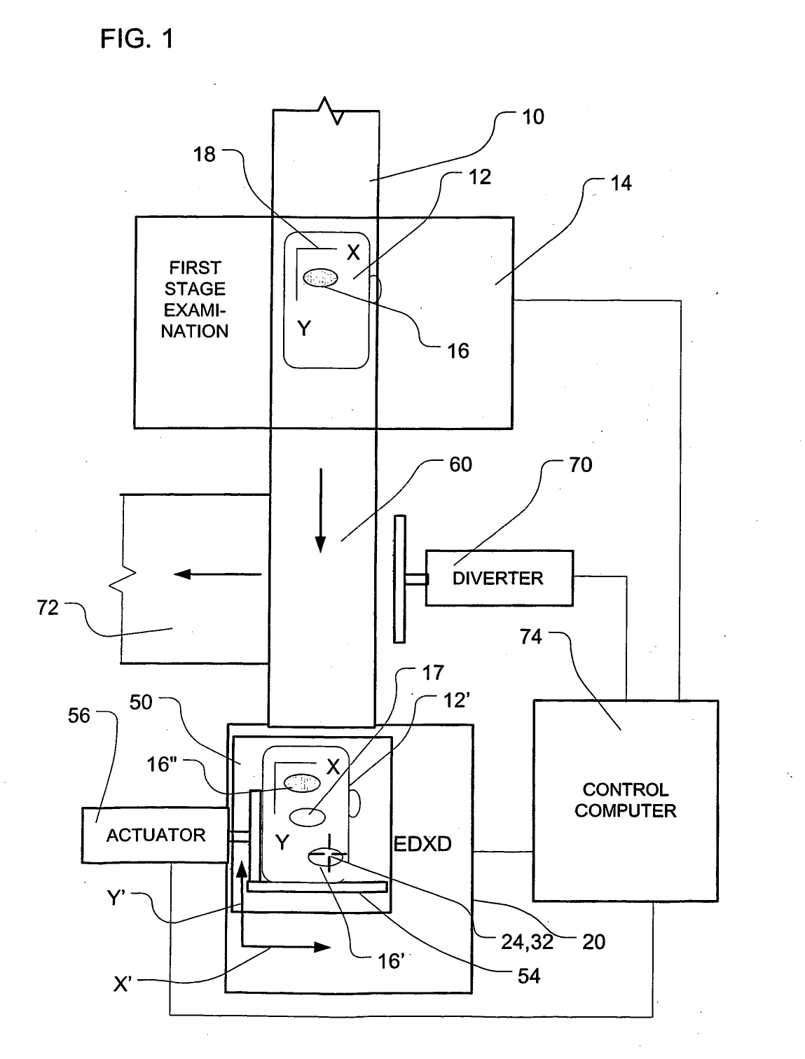

Apparatus according to one embodiment of the invention (FIG. 1) provides a baggage screening system. The apparatus includes an intake conveyor 10 operative to convey a series of articles such as luggage 12 in a downstream direction (towards the bottom of the drawing, as seen in FIG. 1). The intake conveyor feeds into a first stage examination unit 14. The first stage examination unit may be a generally conventional CT scanner equipped with conventional artificial intelligence devices (not shown). The first stage examination unit is arranged, in the normal manner of a CT scanning device, to direct beams of x-rays through articles 12 as the same are presented to the unit 14 and to determine the x-ray transmissivity of each object along numerous different axes. From this transmissivity data, the system assembles a data set representing x-ray absorptivity in each of numerous voxels and, thus, generates a data set representing either a complete three-dimensional image of the object or a series of separate two-dimensional “slice” images. CT-based scanning systems are disclosed, for example, in U.S. Pat. Nos. 6,317,509; 5,182,764; and 5,367,552. The data set in the CT scanning image includes data about x-ray absorptivity in each of numerous volume elements or “voxels.” Logic elements in the first stage examination unit select groups of voxels which, in the aggregate, have characteristics indicative of a threatening object as, for example, a large mass or sheet of contiguous voxels having higher x-ray absorptivity than neighboring voxels.

In the conventional use of such systems, once a suspect region has been identified, the logic within the CT scanning system issues an appropriate warning to indicate that the article is suspect and should be set aside for further examination, typically by a human operator. However, because the CT scanning system acquires an image data set, it inherently acquires information about the location of a suspect region within the object. That is, the coordinates of each voxel constituting a suspect region are known in the frame of reference of the CT scanner itself, as are the coordinates of the edges of the object. Because the edges of the article as, for example, the edges of luggage article 12, are also imaged, their locations are also known in the frame of reference of the CT scanner. Accordingly, the location of a suspect region 16 in the frame of reference 18 of the article 12 itself are also known. In FIG. 1, the frame of reference of the article is exemplified as a Cartesian coordinate system starting from the upper left-hand corner of the article, as seen in FIG. 12. Also, although only two dimensions of such coordinate system are shown, it should be appreciated that the coordinate system 18 also includes a third or Z dimension in the direction perpendicular to the plane of the sheet as seen in FIG. 1 and that the first stage examination system locates the suspect region 16 in this third dimension as well.

Other, similar systems based on imaging technologies include conventional x-ray imaging, multi-energy x-ray imaging and CT techniques which measure x-ray absorptivities at a plurality of different x-ray photon energies so as to provide information about the atomic number of substances present within each voxel in addition to normal absorptivity data. Still other image-based techniques include Compton scattering and x-ray backscatter techniques. The first stage examination unit may include any or all of these techniques and may include any other technique capable of identifying a suspect region having at least some characteristics indicative of the contraband to be detected and capable of providing information as to the location of such region within an article being examined.

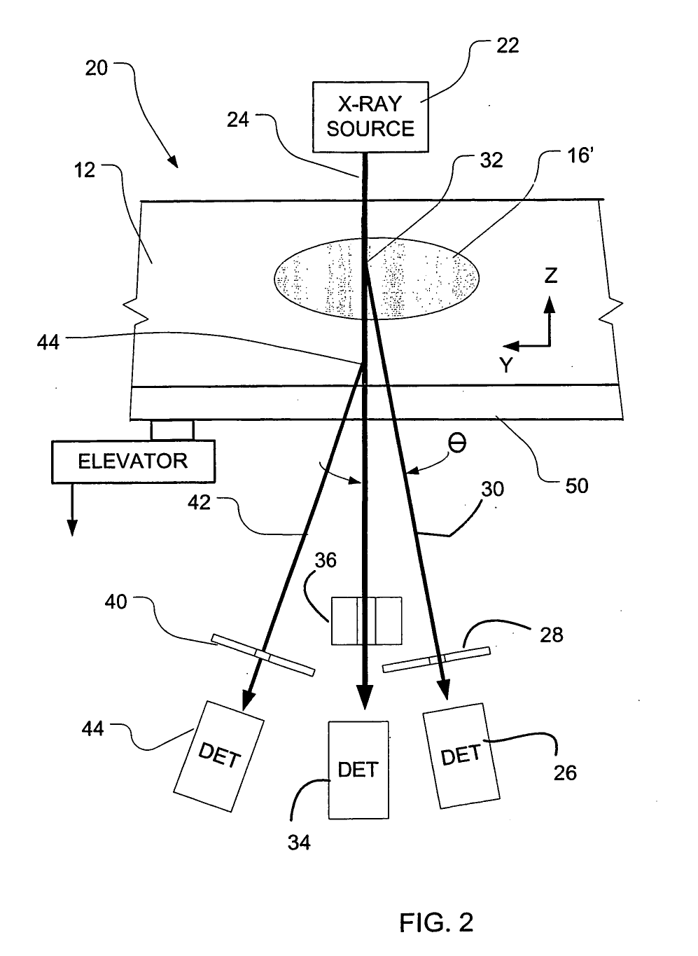

The system further includes an energy dispersive x-ray diffraction (“EDXD”) instrument 20. The EDXD unit 20 may be substantially as described in the aforementioned '850 patent. As indicated in FIG. 2, the EDXD unit includes a polychromatic x-ray source 22 arranged to direct a beam of x-rays having a variety of x-ray photon energies and, hence, a variety of wavelengths along an incident beam path 24. The unit also includes a detector 26 equipped with a collimating device, typically in the form of a radioopaque plate having a slit or bore therein so that the detector 26 is sensitive only to x-rays directed along a diffracted beam path 30 intersecting the incident beam path 24 at a known point 32, referred to herein as the diffraction location. Thus, detector 26 is capable of receiving x-rays diffracted by material present at diffraction location 32 along the diffracted beam path 30. The detector 26 receives x-rays diffracted through a known, fixed angle θ defined by the diffracted beam path and the incident beam path. The EDXD unit further includes a reference detector 34 with a collimating device 36 arranged to detect x-rays transmitted through an object without diffraction, i.e., x-rays passing in a straight line along incident beam path 24. The apparatus may further include one or more additional diffracted x-ray detectors 38 equipped with additional collimating devices 40. Each such additional detector is arranged to detect x-rays diffracted along an additional beam path 42 associated with the particular detector at additional diffraction location 44, also associated with the particular detector. Thus, by using plural diffracted x-ray detectors 26 and 38, the system is arranged to detect x-rays diffracted at a plurality of diffraction locations along the incident beam path 24.

As described in greater detail in the '850 patent, the EDXD unit 20 is arranged to capture a spectrum of the x-rays diffracted at point 32 using detector 26 and to capture a spectrum of the x-rays transmitted along the incident beam path through an object using reference detector 34. The transmitted spectrum captured by detector 34 desirably is modified by applying certain mathematical functions representing peak-broadening effects which occur in the diffracted x-ray spectrum from detector 26. The diffracted x-ray spectrum is normalized, as comparing the x-ray intensity at each wavelength in the diffracted x-ray spectrum with the x-ray intensity at the same wavelength in the modified transmitted x-ray spectrum. This compensates for effects such as non-uniform x-ray intensity at different wavelengths in the x-ray source and non-uniform x-ray absorptivity in an object being examined. The normalized diffracted x-ray spectrum is then examined to extract features such as peak heights, peak wavelengths and peak breadths. Some or all of these features are then subjected to a transform, preferably a transform of the type known as a “homomorphic transform,” most preferably a “cepstrum transform” which yields a further set of features referred to as cepstral coefficients. The original features or the transformed features, such as cepstral coefficients, are then subjected to a classification process using artificial intelligence techniques such as application of a neural network, neural tree network or other types of known processing to determine the probability that the features correspond to the features of a spectrum of a known contraband substance such as a spectrum of a known explosive. This provides an indication as to whether the material in a small volume centered at diffraction location 32 contains the specific class of contraband sought by the classifier. In exactly the same way, processing of the diffracted x-ray spectrum signal from each additional detector 38 provides an indication as to whether such contraband was present at the additional detection location 44 associated with such additional detector.

In the particular embodiment illustrated, the incident beam path 24 of EDXD unit 20 extends perpendicular to the plane of the drawing as seen in FIG. 1 and vertically with respect to the normal gravitational frame of reference. A set of positioning devices is associated with the EDXD unit 20. The positioning devices include a platform 50 linked to an elevator 52 for elevating the platform upwardly and downwardly (into and out of the plane of the drawing in FIG. 1), as well as a mechanical barrier 54, seen in FIG. 1 as a generally L-shaped unit disposed above platform 50 and an actuator 56 for moving barrier 54 in horizontal directions X′, Y′, so as to move an item of luggage 12′ disposed on the platform and engaged with barrier 54. These positioning devices are merely illustrative; essentially any mechanical, electromechanical, pneumatic, hydraulic or other device capable of maneuvering an object in response to commands can be employed. Merely by way of example, a conventional industrial robot can be used in place of the platform, barrier, elevator and actuator.

The EDXD unit 20 most preferably is physically separate from the first stage or initial examination unit 14. That is, the examination units are arranged at different locations, so that both units cannot examine an article while the article remains in a single location. A conveyor 60 is provided for taking articles from the first stage examination unit 14 to the EDXD unit 20. Conveyor 60 may be a simple linear or rotary conveying device such as a belt or roller conveyor, a rotary table or the like. Alternatively, the conveyor 60 may be arranged to bank or store articles temporarily as the units are transferred. Here again, essentially any conventional device capable of moving objects in a pre-determined sequence or in a sequence supplied by an external command unit can be employed as, for example, a conventional industrial robot. Also, conveyor 60 may form an integral part of the positioning devices associated with the EDXD unit 20. For example, the conveyor 60 may extend into the EDXD unit and may be controllable so that controlled movement of the conveyor can be used to position articles within the EDXD unit. Also, a single industrial robot can serve as both the conveying device and the positioning device associated with the EDXD unit. Optionally, a diverter 70 is provided in association with conveyor 60. The diverter is arranged to discharge items from the conveyor 60 along an intermediate discharge path 72 and, hence, route particular items away from the EDXD unit 20.

The system also includes a central control device such as a control computer 74. The control computer 74 may be a general-purpose computer programmed to perform the operations discussed below and equipped with appropriate interface devices (not shown) for the various connections discussed below. The control computer is connected to the first stage examination unit for receipt of information from the first stage unit about each article 12 examined by the first stage unit. Such first stage information includes information as to whether the first stage examination unit has identified any suspect regions within the particular article and, if so, the locations of all such suspect regions in the frame of reference 18 of that particular item. The information received from the first stage unit may also include additional information defining features of each suspect region as, for example, its size, shape, uniformity of x-ray density and the like, as measured by the first stage examination unit. The control computer also may be arranged to receive information from the first stage examination unit, or from external sources, concerning overall characteristics of the object as, for example, the number of suspect regions within the object and information as to the provenance of the object as, for example, whether a passenger who checked the object has recently visited a country known to harbor terrorists or whether the object has been transferred from a flight originating at an airport known to have lax security measures. The control computer also receives spectral information from EDXD unit 20. Although the control computer is shown as a separate element from the first stage examination unit and the EDXD unit, some or all of the control and signal processing functions of these units may be integrated in the control computer. For example, the control computer may perform the normalization and classification functions of the EDXD unit discussed above based on the spectral data acquired by the EDXD unit. The control computer is also linked to the diverter 70 and to the positioning devices associated with the EDXD unit as, for example, to elevator 52 (FIG. 2) and actuator 56.

In operation, a series of articles such as a series of luggage articles 12 are provided as in-feed conveyor 10. The first stage examination unit conducts operations as discussed above to identify suspect regions within articles. Each article passes out the first stage examination unit along the transfer conveyor 60. If no suspect regions have been identified in a particular article, the control computer operates the diverter 70 to discharge that particular article from the transfer conveyor along the auxiliary discharge path 72 and no further action is taken with respect to that article. Suspect articles, i.e., those articles which contain at least one suspect region identified by the first stage examination unit, are transported by conveyor 60 to EDXD unit 20 in sequence. When each suspect article arrives at the EDXD unit, it is engaged with barrier 54 and held on elevator 50. The control computer commands these elements to position the object so that at least one of the diffraction locations of the EDXD unit is positioned within a suspect region 16′ of that article. Of course, as the dimensions of the articles may vary and as the locations of suspect regions within different articles will vary, the actuator 56 and elevator 52 typically must move each article to a specific position relative to the frame of reference of the EDXD unit to achieve the required alignment between a suspect region and a diffraction location. These actions are performed under the command of the control computer based upon the suspect region location data provided by the first stage examination unit. The EDXD unit is actuated to apply an x-ray beam from source 22 (FIG. 2). X-rays diffracted at least those diffraction locations disposed within a suspect region of the article are monitored to provide diffracted x-ray spectrum data. As discussed above, the EDXD unit processes the diffraction spectrum data to derive a probability that the diffraction spectrum represents contraband of known type as, for example, known types of explosives. Optionally, the control computer may actuate the positioning devices such as actuator 56 and elevator 52 to move the object slightly so as to align a further portion of the same suspect region with one or more diffraction locations, whereupon the EDXD unit 20 acquires additional diffracted x-ray spectrum data. Where the first stage examination data from unit 14 indicates the presence of two or more suspect regions, the control computer repositions the object and repeats the process to obtain further diffracted x-ray spectrum data from another suspect region. The control computer classifies the object as either most likely containing contraband or most likely not containing contraband, based at least in part on the results of the EDXD examination steps. After EDXD examination, each object is removed from the system either manually or by automated devices (not shown). In one embodiment, the classification is based solely on data acquired in EDXD examination. That is, if the diffracted x-ray spectrum indicates the presence of a known type of contraband, the article is treated as containing contraband; if not, the article is treated as not containing contraband. Alternatively, the classification of the object can be based in part upon the EDXD information and in part upon information acquired by the first stage examination unit. Information from the various sources can be combined using a rule-based system with rules based on the findings of both first stage and EDXD examination. Alternatively or additionally, the classification can be based on a probabilistic weighting of various factors including both first stage examination data and EDXD data as, for example, in a neural network with inputs representing these factors. Likewise, provenance data or other data from outside of the system can be incorporated in the classification scheme.

In operation, it is only necessary to apply EDXD examination at points within the suspect locations. Portions of suspect articles outside of the suspect locations need not be examined by EDXD. Therefore, the EDXD examination of the article can be completed rapidly. Stated another way, the EDXD examination is concentrated in areas where it will do the most good. Also, because identification of a particular article as a suspect article in the first stage examination unit does not result in a false positive reading if it turns out that the particular article did not contain explosives, the logic used in the first stage examination unit may be set to suppress false negative readings at the expense of generating considerably more false positive readings. Most or all of the false positives will be rejected by the EDXD unit.

Numerous variations and combinations of the features discussed above can be employed. For example, the EDXD unit may perform some examinations of locations within suspect articles outside of the suspect regions. Also, the diverter 70 and auxiliary path 72 may be omitted so that all of the objects presented to the first stage examination unit are passed to EDXD unit 20 and subjected to EDXD examination. In this case, the EDXD examination unit and associated positioning devices may be commanded to perform EDXD examinations at random locations within each article that does not have suspect regions. Also, the system may include a plurality of first stage examination units or a plurality of EDXD units or both. The first stage and EDXD units need not be provided in equal numbers; the numbers of each type of unit will depend upon the average throughput of each unit.

Preferably, the conveyor 60 is arranged to move the articles without reorienting them relative to gravity and without subjecting them to high accelerations. For example, the conveyor units may be arranged to move articles from the first stage examination unit to the EDXD unit with maximum accelerations of about 3 g (about 30 meters/second²) or less and preferably about 1 g (about 10 meters/second²) or less. Such gentle handling helps to assure that objects, including contraband within each article remain in the same position within the article as the article passes from the first stage examination unit to the EDXD unit. In the system discussed above, the control computer forwards suspect region location data to the positioning system. However, this is not essential. For example, the first stage examination unit may be arranged to encode each object with the suspect region location data as, for example, by applying a tag or label containing such data in machine-readable format such as a bar code.

In a further variant, the EDXD unit may be physically combined with the first stage examination unit so that each article remains stationary from the time of first stage examination to the time of EDXD examination. However, it is highly preferred to keep the units separate so that the units can operate separately on different articles in the sequence. For example, as seen in FIG. 1, the first stage examination unit is performing first stage examination of one article 12 at the same time as the EDXD unit is performing EDXD examination of a preceding article 12′. Further, in the embodiments discussed above, the positioning devices are arranged to move the articles relative to the incident beam path and diffraction locations of the EDXD unit. In a variant, the positioning devices may be arranged to move the beam path and diffraction locations of the EDXD unit as, for example, by pivoting or translating the entire EDXD unit while the article remains stationary.

Preferably, the X-ray source in the EDXD unit 20 is arranged to operate intermittently, under the control of control computer 74. The control computer 74 actuates the X-ray source 22 to emit brief bursts of relatively intense X-rays. Preferably, the X-ray source is actuated by control computer 74 in coordination with operation of the positioning devices such as actuator 56 and elevator 52. Thus, the X-ray source is operated to emit a burst of X-rays after the positioning devices have moved the article to a desired position, with a suspect region 16′ aligned with the diffraction location. The use of a high-intensity source permits acquisition of spectral data with reasonable signal-to-noise ratio in a short time. Although such a source typically has a limited duty cycle, this does not pose a problem because the inactive or “off” portions of the duty cycle occur during the time consumed in moving the article. Stated another way, the control computer 74 receives information designating a set of suspect regions within each article from the initial examination unit 14 and actuates the positioning system to move that article intermittently, so as to bring the different suspect regions 16′ and 16″ in the set into alignment with a diffraction location, such as location 32, defined by the EDXD apparatus in sequence. While each suspect region is aligned with the diffraction location, the control computer actuates X-ray source 22 to emit. However, during movement of the article relative to the diffraction region, while no suspect region is aligned with the diffraction region, the X-ray source is not emitting. For example, while a non-suspect region 17 is aligned with the diffraction location 32, during movement of the article, the X-ray source does not emit.

In a variant, the set of regions to be examined may be selected by the control computer at random or according to some plan not based on initial examination. Although this variant does not provide the advantage of selecting suspect regions, it does provide the advantages associated with intermittent actuation of the X-ray source.

As these and other variations and combinations of the features discussed above can be utilized without departing from the present invention, the foregoing description of the preferred embodiment should be taken by way of illustration rather than by way of limitation of the present invention.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

### INDUSTRIAL APPLICABILITY

The present invention can be used in the security and transportation industry as, for example, in airline baggage screening and customs inspection.

1. Apparatus for detecting contraband in a series of articles comprising:
(a) a first-stage examination device operative to examine each of a series of articles and provide suspect region location information about at least some of the articles, the region location information for each such article including a location of at least one suspect region of the article which is more likely than other regions of such article to contain contraband;
(b) an EDXD examination device physically separate from said first stage examination device, said EDXD examination device including:
(i) an X-ray source for directing X-rays having a plurality of wavelengths along an incident beam path;
(ii) at least one X-ray detector operative to detect X-rays diffracted along at least one diffracted beam path intersecting the incident beam path at at least one diffraction location along the incident beam path and providing one or more signals representing one or more diffraction spectra of material present at said one or more diffraction locations;
(c) a positioning mechanism responsive to the suspect region information for positioning each of said at least some articles relative to the EDXD device so that at least one said diffraction location is disposed within at least one suspect region of that article, whereby the one or more signals from the EDXD device will include at least one suspect region diffraction signal representing at least one diffraction spectrum of material in at least one said suspect region; and
(d) a classifier for classifying each of said at least some articles based at least in part upon at least one said suspect region diffraction signal.

2. Apparatus as claimed in claim 1 wherein said first-stage examination device includes first-stage signal processing apparatus for deriving said suspect region information automatically.

3. Apparatus as claimed in claim 2 wherein said first-stage examination device includes a pre-classifier operative to exclude at least some of the series of articles originally presented to the first-stage examination device from examination by said EDXD device.

4. Apparatus as claimed in claim 1 further comprising a conveyor mechanism connected to said first-stage examination device and to said EDXD examination device for automatically moving said at least some of said articles from said first-stage examination device to said EDXD examination device.

5. Apparatus as claimed in claim 4 wherein said conveyor mechanism is operative to maintain each of said at least some of said articles in substantially constant orientation relative to gravity during movement to said EDXD examination device.

6. Apparatus as claimed in claim 5 wherein said conveyor mechanism is operative to move each of said at least some of said articles with a maximum acceleration of about 30 m/s² or less from said first-stage examination device to said EDXD examination device.

7. Apparatus as claimed in claim 1 wherein said at least one diffraction region includes a plurality of said diffraction regions.

8. Apparatus as claimed in claim 1 wherein said X-ray source in said EDXD examination device includes a flash X-ray source.

9. Apparatus as claimed in claim 1 wherein said EDXD examination device includes a transmitted X-ray monitoring device operative to provide a spectrum of X-rays transmitted through an article along said incident beam path.

10. Apparatus as claimed in claim 1 wherein said first-stage examination device includes apparatus selected from the group consisting of CT scanners, Multi-energy X-ray scanners, Compton scattering scanners and X-ray backscatter scanners.

11. Apparatus as claimed in claim 1 wherein said first-stage examination device includes a CT scanner.

12. Apparatus as claimed in claim 1 wherein said classifier includes a probabilistic classification device operative to classify an object based at least in part upon a plurality of features of at least one said suspect region diffraction signal.

13. Apparatus as claimed in claim 1 wherein said first-stage examination device is operative to provide first-stage feature information representing one or more features of each of said at least some articles and wherein said classifier is operative to classify objects based at least in part on said first-stage feature information and at least one said suspect region diffraction signal.

14. Apparatus as claimed in claim 1 wherein said X-ray source and said at least one detector are fixedly mounted so that each said diffraction location is provided at a fixed position, and wherein said positioning mechanism is operative to move said at least some articles.

15. A method of examining a series of articles to detect contraband concealed therein comprising the steps of:
(a) at an initial examination unit, conducting an initial examination of each of a series of articles to identify in at least some of said articles suspect regions which are more likely than other regions of such article to contain contraband and to provide location information including the locations of the suspect regions within articles where such suspect regions are found;
(b) moving at least those articles in which suspect regions are identified to an EDXD examination unit physically separate from said initial examination unit;
(b) at said EDXD examination unit, conducting EDXD examination of at least those articles in which suspect regions are identified so as to provide one or more suspect region diffraction signals representing one or more X-ray diffraction spectra of material present in said suspect regions; and
(c) classifying at least some of said articles based at least in part upon said suspect region diffraction signals.

16. A method as claimed in claim 15 wherein said step of conducting EDXD examination is performed without conducting EDXD examination of at least some regions other than said suspect regions of at least some of said articles in which suspect regions are identified.

17. A method as claimed in claim 15 wherein said step of conducting EDXD examination is performed only on those articles in which suspect regions are identified in said initial examination step.

18. A method as claimed in claim 15 wherein said initial examination step includes the step of automatically identifying said suspect regions.

19. A method as claimed in claim 15 wherein said initial examination step includes ascertaining first-stage feature information representing one or more features of each article and wherein said classifying step is performed based upon based at least in part on said first-stage feature information and at least one said suspect region diffraction signal.

20. A method as claimed in claim 15 wherein said moving step includes the step of automatically moving at least those articles in which suspect regions are identified between said initial examination unit and said EDXD examination unit while maintaining such articles in substantially constant orientation relative to gravity.

21. A method of conducting EDXD examination comprising the steps of:
(a) specifying a set of regions within an object to be examined, said regions including less than all of said object;
(b) moving said object relative to EDXD apparatus incorporating an X-ray source adapted to direct an incident X-ray beam along an incident beam path and a detector sensitive to x-rays directed along a diffracted beam path intersecting the incident beam path at a diffraction location, said moving step being performed so as to successively align regions in said set with said diffraction location;
(c) actuating said X-ray source intermittently, in synchronism with said moving step, so that the X-ray source provides said incident X-ray beam when a region in said set is aligned with said first diffraction location but does not provide said incident X-ray beam during at least some times when no region in said set is aligned with said diffraction location; and
(d) acquiring spectra of diffracted X-rays from regions in said set during said actuating step using said detector.

22. A method as claimed in claim 21 wherein said step of specifying said set of regions in said article includes the step of conducting an initial examination of said article using an initial examination method other than EDXD so as to identify suspect regions which are more likely than other regions of said article to contain contraband.

23. A method as claimed in claim 22 wherein said step of conducting an initial examination includes deriving location information specifying the locations of said suspect regions within the article.

24. A method as claimed in claim 21 wherein said moving step is performed intermittently.

25. Apparatus for examining articles comprising:
(a) an X-ray source adapted to direct an incident X-ray beam along an incident beam path and a detector sensitive to x-rays directed along a diffracted beam path intersecting the incident beam path at a diffraction location;
(b) a positioning system operative to move an article to be examined and said diffraction location relative to one another; and
(c) a controller connected to said positioning system and to said X-ray source, said controller being operative to actuate said X-ray source intermittently, in synchronism with movement of the article by said positioning system, to supply said incident beam when a region in a preselected set of regions within the article is aligned with said diffraction location and to not provide said incident X-ray beam during at least some times when no region in said set is aligned with said diffraction location.

26. Apparatus as claimed in claim 25 further comprising an initial examination unit operative to identify suspect regions which are more likely than other regions of said article to contain contraband, said controller being connected to said initial examination unit, said preselected set of regions including said suspect regions.
